(19) United States
(12) Patent Application Publication
(10) Pub. No.: US 2010/0191498 A1
(43) Pub. Date: Jul. 29, 2010

(54) Data Inquiry System of Power Bank

(76) Inventors: Shih-Hui CHEN, Taoyuan Hsieh (TW); Chin-Tien Lin, Taoyuan Hsieh (TW)

Correspondence Address: Jackson Intellectual Property Group PLLC, 106 Starvale Lane, Shipman, VA, 22971, US

(21) Appl. No.: 12/202,875

(22) Filed: Sep. 2, 2008

(51) Int. Cl. G06F 19/00; G06F 17/30

(52) U.S. Cl. 702/108; 707/705; 707/802; 707/E17.044

(57) ABSTRACT

The present invention discloses an inquiry system having a database, a testing module, and a memory unit built in a power bank. The testing module and the database conduct an information exchange with a computer through the memory unit, such that consumers can obtain specification and teaching content related data of the power bank by using the computer, and further perform a battery function test to the connected power bank.

### BACKGROUND OF THE INVENTION

(a) Field of the Invention

The present invention relates to a computer inquiry system, and more particularly to an inquiry system provided for consumers to obtain specification and teaching content related data from a power bank by using a computer, and perform a battery function test to a connected power bank.

(b) Description of the Related Art

As digital electronic products become necessary equipments, we need digital electronic products in our daily life, tour, business trip or work. For example, we use a digital camera, a digital camcorder or a MP4 player in a tour, and a personal digital assistant or a notebook computer in a business trip, and these digital electronic products bring us tremendous convenience.

As to the digital electronic products used at a place without an access of utility power, the duration of battery become a major issue to users. Furthermore, the battery made by the original manufacturer is very expensive, and the battery duration is very short, the power supply becomes a drawback of the electronic products particularly when the battery cannot be recharged, and thus these digital electronic products cannot be utilized fully, and a power bank is developed and introduced to the market.

In general, a power bank includes at least one built-in rechargeable battery, and a USB cable is connected between the power bank and an electronic device for supplying power to the electronic device. In other words, the power bank is an external device with power storage and basic transmission functions, and increasingly more added-on functions are developed from the power bank.

Since the power bank integrates many other added-on functions, manufacturers attempt to introduce and provide more specifications and models of power banks for the choice and use by consumers, and a manufacturer may produce several different models of power banks, and their operations may vary according to the different added-on functions.

Further, after the built-in rechargeable battery of the power bank has gone through repeated charging and discharging processes, the battery function may be deteriorated, and thus it is an important subject for manufacturers to develop a power bank with an inquiry system provided for consumers to obtain the related data of the power bank and know about the battery function of the power bank.

### SUMMARY OF THE INVENTION

In view of the shortcomings of the prior art, it is a primary objective of the present invention to provide an inquiry system for consumers to use a computer to obtain specification and teaching content related data of a power bank and further perform a battery function test of the power bank.

To achieve the foregoing objective, the inquiry system comprises a database, a testing module, and a memory unit built in the power bank, wherein the database and the testing module can be built in a website directly or built in a computer through downloading from a website or reading from an optical disk, and the database further comprises a basic data inquiry unit, a how-to-use data unit, and a battery function testing unit.

The inquiry system performs an information exchange with the memory unit through the computer and the testing module and the database for consumers to use a computer to obtain specification and teaching content related data of a power bank and further perform a battery function test of the power bank.

An effect of the invention is to build a basic data inquiry unit of a database for users to obtain detailed product information.

Another effect of the invention is to build a how-to-use data unit of the database for users to obtain a complete product operating method.

A further effect of the invention is to build a battery function testing unit of the database for consumers to know about the battery function of a connected power bank immediately and get ready for replacing or charging the battery in advance.

### BRIEF DESCRIPTION OF THE DRAWINGS

FIG. 1 is a schematic view of using a power bank of the invention;

FIG. 2 is a schematic view of a basic structure of an inquiry system of the present invention;

FIG. 3 is a schematic view of a basic structure of a database of the invention;

FIG. 4 is a flow chart of an inquiry system in accordance with a first preferred embodiment of the invention;

FIG. 5 is a flow chart of an inquiry system in accordance with a second preferred embodiment of the invention; and

FIG. 6 is a flow chart of an inquiry system in accordance with a third preferred embodiment of the invention.

### DETAILED DESCRIPTION OF THE PREFERRED EMBODIMENTS

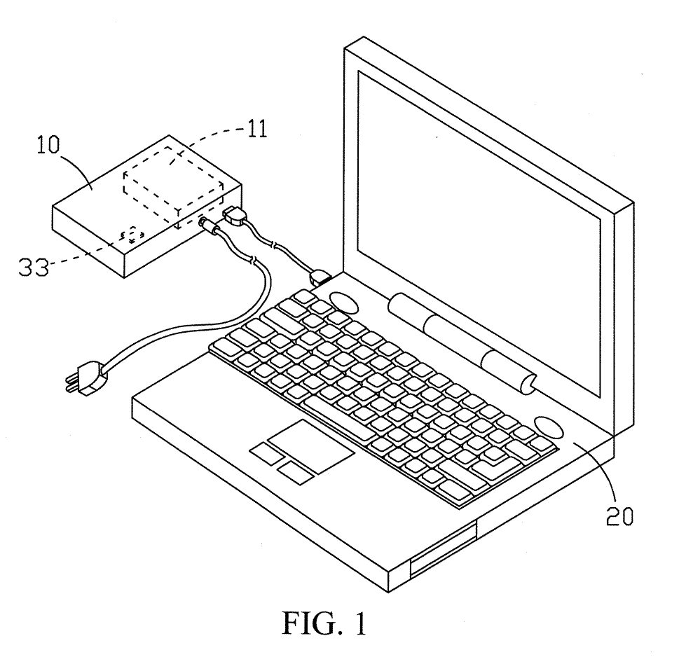

With reference to FIG. 1 for an inquiry system in accordance with a third preferred embodiment of the present invention, the inquiry system is provided for consumers to use a computer 20 to obtain specification and teaching content related data from a power bank 10 and further perform a battery function test for the connected power bank 10.

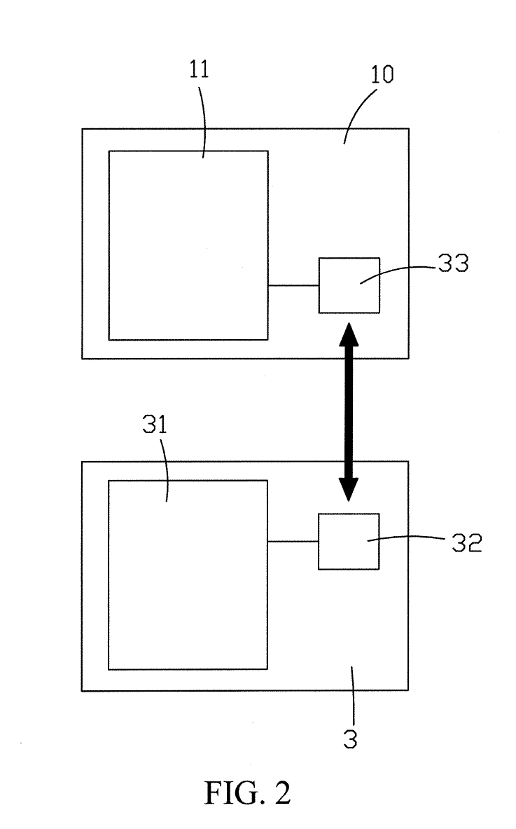

With reference to FIG. 2 as well, the inquiry system comprises a database 31, a testing module 32, and a memory unit 33.

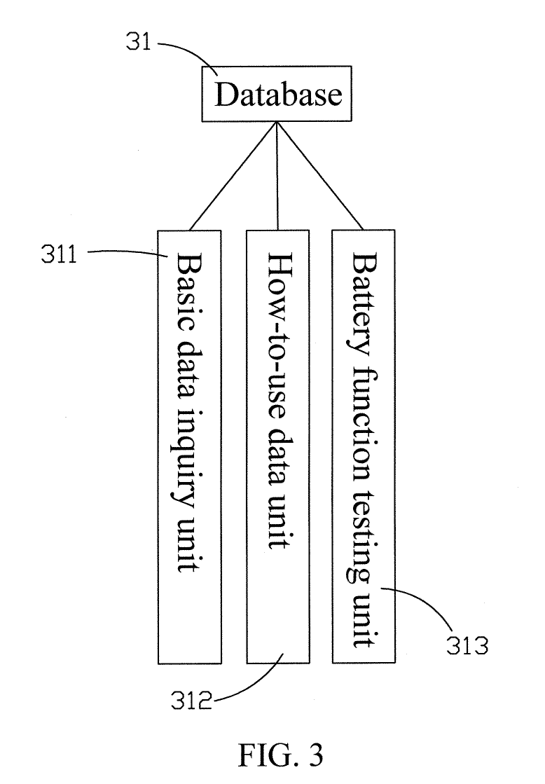

The database 31 and the testing module 32 are integrated into a system software 3, and the system software 3 can be built directly into a website, or downloaded from the website into a computer or reading from an optical disk by users. In FIG. 3, the database 31 further comprises a basic data inquiry unit 311, a how-to-use data unit 312, and a battery function testing unit 313, and the memory unit 33 as shown in FIG. 1 is built in the power bank 10 for performing an information exchange with the computer 20.

In FIGS. 1 and 2, an information exchange is performed between the inquiry system with the memory unit 33 and the testing module 32 and the database 31 of the system software 3 through the computer 20, and provided for consumers to use a computer to obtain specification and teaching content related data of the power bank 10, and further perform a function test of the battery 11 of the power bank 10.

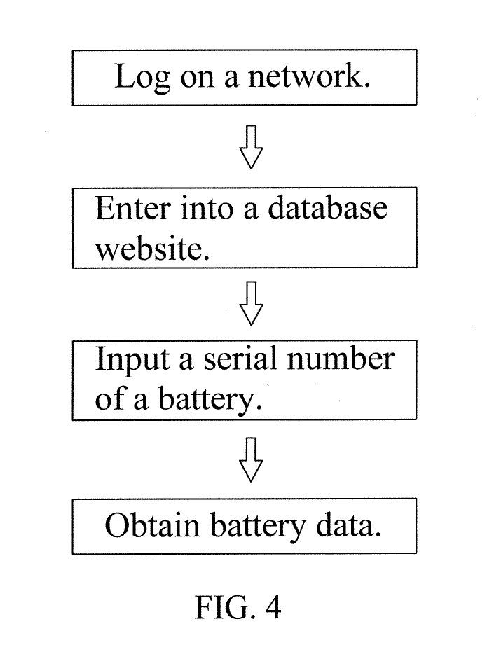

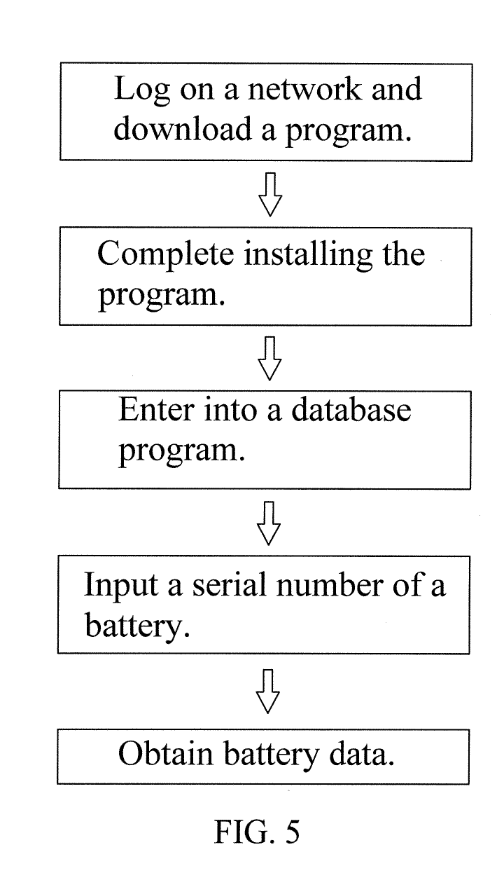

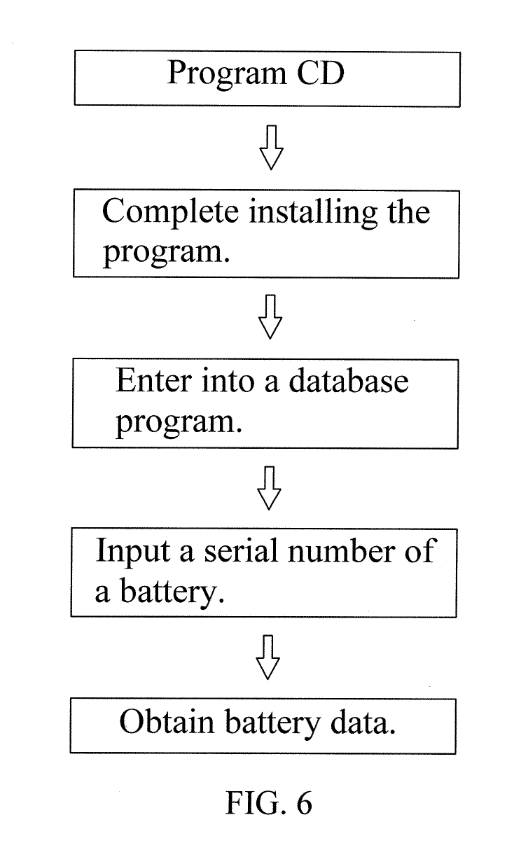

In a practical application, a consumer enters into a website having an inquiry system directly via a network connection and inputs a related product number as shown in FIG. 4, the user can obtain specification and teaching content related data of the power bank, or the consumer enters directly into a website having an inquiry system via a network connection and downloads a system software of the inquiry system as shown in FIG. 5, such that after the system software is installed, the consumer enters a related product number and obtains the related specification and teaching content of the power bank, or the consumer uses an optical disk of the system software of the inquiry system for installing the system software as shown in FIG. 6, and inputs a related product number to obtain the specification and teaching content related data of the power bank.

Since the inquiry system builds a basic data inquiry unit and a how-to-use data unit in the database, therefore consumers can obtain the detailed product information and the complete operating demonstration and description of a product. Particularly, the battery function testing unit and the detection module can be operated to give the information about the battery function of a connected power bank and allow users to get ready for replacing or charging the battery in advance.

I claim:

1. A data inquiry system of a power bank, comprising:
a system software, integrated with a database and a testing module; and
a memory unit, built in the power bank, for performing an information exchange with the database and the testing module.

2. The data inquiry system of a power bank as recited in claim 1, wherein the database further comprises a basic data inquiry unit, a how-to-use data unit, and a battery function testing unit.

3. The data inquiry system of a power bank as recited in claim 1, wherein the system software is built in a website.

4. The data inquiry system of a power bank as recited in claim 3, wherein the database further comprises a basic data inquiry unit, a how-to-use data unit, and a battery function testing unit.

5. The data inquiry system of a power bank as recited in claim 1, wherein the system software is built into a computer by downloading the system software from a website to the computer.

6. The data inquiry system of a power bank as recited in claim 5, wherein the database further comprises a basic data inquiry unit, a how-to-use data unit, and a battery function testing unit.

7. The data inquiry system of a power bank as recited in claim 1, wherein the system software is built in a computer by reading the system software from an optical disk.

8. The data inquiry system of a power bank as recited in claim 7, wherein the database further comprises a basic data inquiry unit, a how-to-use data unit, and a battery function testing unit.
